(19) United States
(12) Patent Application Publication
(10) Pub. No.: US 2003/0102983 A1
(43) Pub. Date: Jun. 5, 2003

(54) Wireless heartbeat detector

(76) Inventor: Su-Yueh Hsieh Hung, San Chung (TW)

Correspondence Address: BIRCH STEWART KOLASCH & BIRCH, PO BOX 747, FALLS CHURCH, VA, 22040-0747, US

(21) Appl. No.: 10/001,818

(22) Filed: Dec. 5, 2001

(51) Int. Cl. H04Q 9/00

(52) U.S. Cl. 340/870.07; 340/573.1; 340/539.12; 600/301

(57) ABSTRACT

A wireless heartbeat detector includes a wireless pulsation detector that detects the heartbeat signals and a wireless receiving display for showing heartbeat value. The wireless pulsation detector receives the heartbeat signals and transmits the signals to the wireless receiving display. When signals come in, the program processor of the wireless receiving display calculates and then the heartbeat value is displayed on the display. The wireless pulsation detector contains at least one heartbeat detector, a signal processing circuitry and a wireless signal transmission circuitry. The heartbeat detector can be fixed on earlobe or finger tips. The pulsation signals are received and converted by the signal processing circuitry of the wireless pulsation detector into more stable signals. Then the signals are encoded and transmitted out through wireless signal transmission circuitry.

### BACKGROUND OF THE INVENTION

I. Field of the Invention

This invention relates generally to a wireless heartbeat detector and, more specifically, to a wireless heartbeat detector that offers a simple, convenient attachment method for pulsation detector to receive the accurate and more stable heartbeat signals, and transmit those signals with wireless mechanism to the signal receiver and display.

II. Description of the Prior Art

Heretofore, it is known that the traditional heartbeat detectors can be classified into two categories:

One is the wired heartbeat detector that has a signal wire tied to displays to show the heartbeat value. However, while people exercise, the swaying might cause signal unstable that results inaccuracy.

The other is a kind of wireless heartbeat detector, the detectors are carried on the chest or held in hand. Yet to have the detector on the chest is not so convenient for the users, to hold in hand might also causes inaccuracy for the different strength and the swaying. Moreover, conventional wireless transmission is by infrared rays, which may have instable signals due to the deviation of direction.

All of above have room for improvement.

### SUMMARY OF THE INVENTION

It is therefore a primary object of the invention to provide a wireless heartbeat detector that has the pulsation detector firmly attached to the users. Such arrangement achieves not only easy and convenient to put the device on, but also not so easy to sway when users do exercise or sway hands so that the heartbeat signals tend to be more stable and reliable.

A further object of the invention to provide a wireless heartbeat detector that detects signals by infrared rays and then transmits signals to the receiver through radio frequency so as to increase the stability of signal transmission.

In order to achieve the objective set forth, a wireless heartbeat detector in accordance with the present invention comprises a wireless pulsation detector and a wireless receiving display. The wireless pulsation detector receives the heartbeat signals and transmits the signals to the wireless receiving display. The wireless receiving display can be connected to a display apparatus or carried on wrist or on waist. When signals come in, the program processor of the wireless receiving display can calculate and display the heartbeat value on the display. The wireless pulsation detector contains at least one heartbeat detector, a signal processing circuitry and a wireless signal transmission circuitry. The heartbeat detector can be fixed on earlobe or finger tips. The pulsation signals are received and converted, amplified by the signal processing circuitry of the wireless pulsation detector, the processed and more stable signals then are encoded and transmitted out through radio frequency wireless signal transmission circuitry. The wireless receiving circuitry of the wireless receiving display receives and decodes the signals and input the processed signals into the program processor to calculate the heartbeat value, the number is then display through the display.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is a block diagram of the present invention;

FIG. 2 is a perspective view of an embodiment of the present invention;

FIG. 3 is a perspective view of a further embodiment of the present invention;

FIG. 4 is a perspective view of another embodiment of the present invention;

FIG. 5 is a perspective view of a further embodiment of the present invention;

FIG. 6 is a perspective view of a further embodiment of the present invention.

### DESCRIPTION OF THE PREFERRED EMBODIMENT

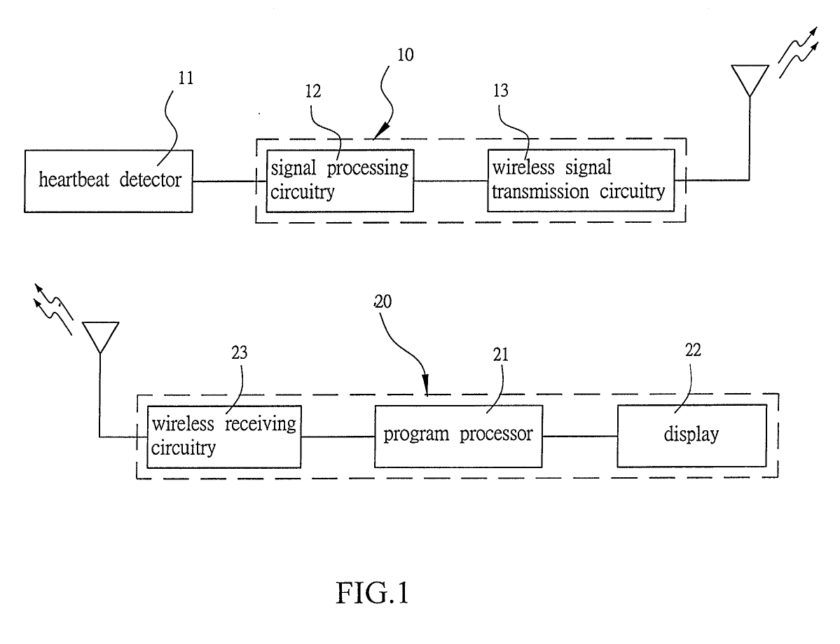

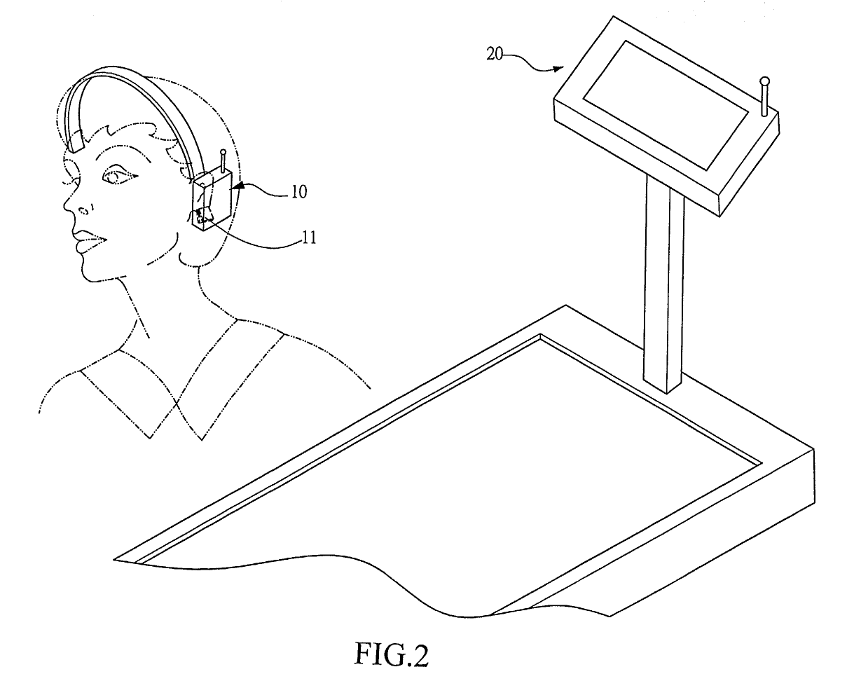

Referring to FIG. 1, the present invention is composed of a wireless pulsation detector 10 and a wireless receiving display 20. The wireless pulsation detector 10 receives the heartbeat signals and transmits the signals to the wireless receiving display 20. The wireless receiving display 20 can be connected to a display apparatus (as shown in FIG. 2) or carried on wrist or on waist. When signals come in, the program processor 21 of the wireless receiving display 20 can calculate and display the heartbeat value on the display 22. The major features are as following:

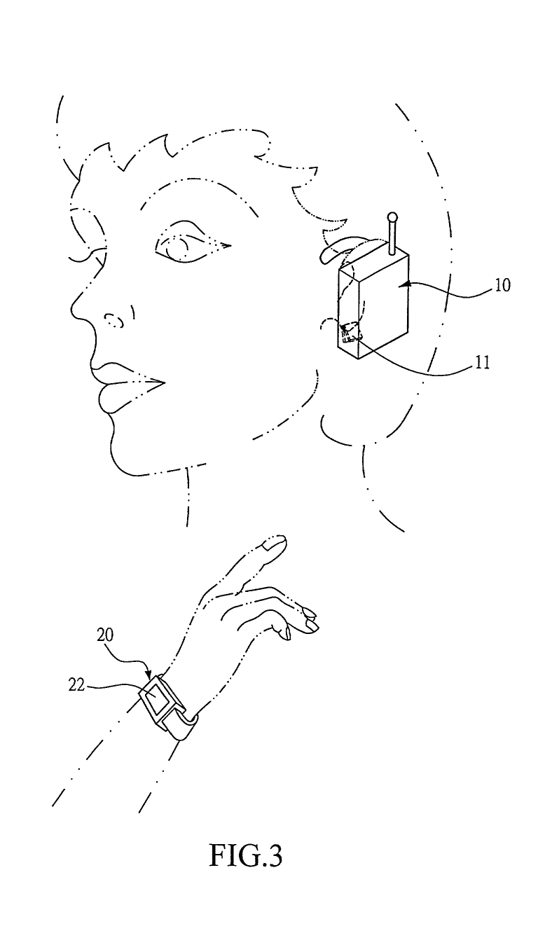

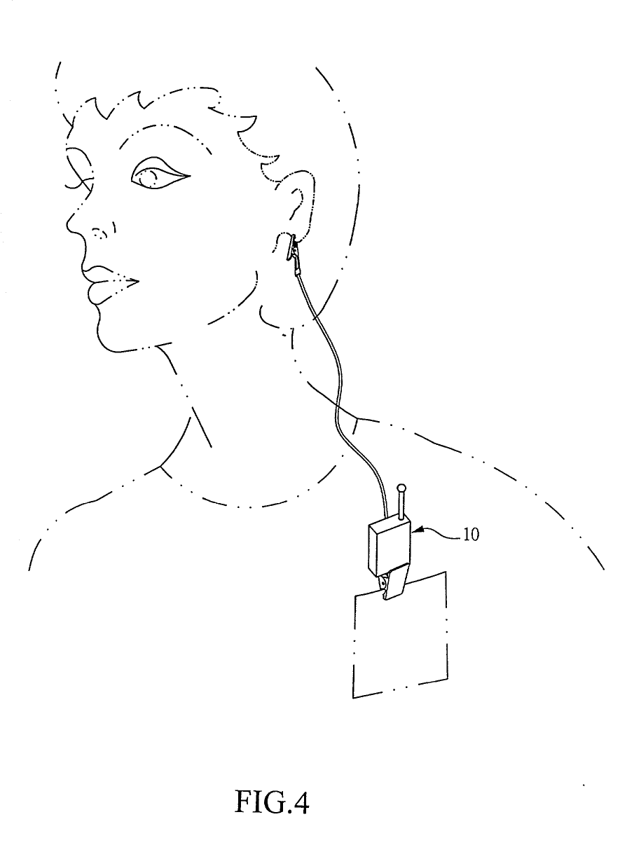

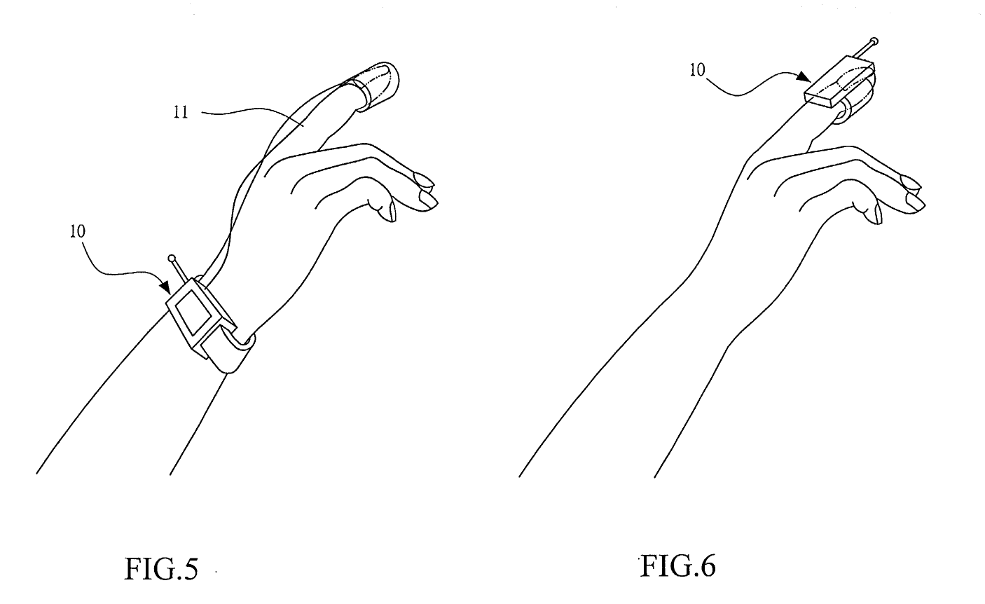

The wireless pulsation detector 10 contains at least one heartbeat detector 11, a signal processing circuitry 12 and a wireless signal transmission circuitry 13. The heartbeat detector 11 is an infrared detector (the infrared detector has two types: reflection and penetration); the heartbeat detector 11 can be fixed on earlobe (as shown in FIG. 3 and FIG. 4) or finger tips (as shown in FIG. 5 and FIG. 6). The pulsation signals are received through infrared method and converted, amplified by the signal processing circuitry 12 of the wireless pulsation detector 10. The processed and more stable signals then are encoded and transmitted out through the wireless signal transmission circuitry 13 (as shown in FIG. 1).

By above description and refer to FIG. 2 to FIG. 6, the wireless pulsation detector 10 is a main body contains the heartbeat detector I1, the signal processing circuitry 12 and the wireless signal transmission circuitry 13. The heartbeat detector 11 is installed on the back of the main body (as shown in FIG. 2, FIG. 3 and FIG. 6). The heartbeat detector 11 can also be installed externally and connected to the wireless pulsation detector 10 with a wire (as shown in FIG. 4 and FIG. 5). Therefore the wireless pulsation detector 10 can be in a headphone, an earflap, a cloth clip or a watch shape to be fixed on head, ear, collar, ear, wrist or finger tip, the heartbeat detector 11 can be placed on earlobe or finger tip of the users. When the heartbeat detector 11 picks up the pulsation signals from earlobe or finger tip of the users, the pulsation signals are converted, amplified by the signal processing circuitry 12, the processed and more stable signals then are encoded and transmitted out through wireless signal transmission circuitry 13; the wireless receiving circuitry 23 of the wireless receiving display 20 receives and decodes the signals and input the processed signals into the program processor 21 to calculate the heartbeat value, the number is then display through the display 22.

In FIG. 2, the wireless pulsation detector 10 can also contain a walkman radio unit for relaxation.

The wireless pulsation detector 10 of the present invention is no only easy and convenient to put on, but also not so easy to sway when users do exercise or sway hands, the heartbeat signals tend to be more stable and reliable.

While a preferred embodiment of the invention has been shown and described in detail, it will be readily understood and appreciated that numerous omissions, changes and additions may be made without departing from the spirit and scope of the invention.

What is claimed is:

1. A wireless heartbeat detector comprising:
a wireless pulsation detector for detecting heartbeat signals and transmitting heartbeat signals, and a wireless receiving display for displaying the heartbeat value;
wherein said wireless pulsation detector having at least one heartbeat detector, a signal processing circuitry and a wireless signal transmission circuitry; said heartbeat detector is an infrared detector to detect the pulsation signals; said signal processing circuitry receives, converts and amplifies the signals into more stable signals; said wireless signal transmission circuitry encodes and transmits the stable signals;
when said heartbeat detector detects the pulsation signals from earlobe or finger tips, the pulsation signals are received, converted and amplified by said signal processing circuitry, the processed and more stable signals then are encoded and transmitted out through said radio frequency wireless signal transmission circuitry.

2. The wireless heartbeat detector recited in claim 1, wherein said heartbeat detector is reflection infrared detector or penetration infrared detector.

3. The wireless heartbeat detector recited in claim 1, wherein said wireless receiving display is connected to a display apparatus, or carried on wrist or on waist.

4. The wireless heartbeat detector recited in claim 1, wherein said wireless signal transmission circuitry can be placed on the cloth, heads, earlobe collars, finger tips or wrist of the users.
